(19) United States
(12) Patent Application Publication
(10) Pub. No.: US 2007/0039943 A1
(43) Pub. Date: Feb. 22, 2007

(54) Heatable tool

(75) Inventors: August Burr, Bretzfeld (DE); Andreas Muller, Cleebronn (DE); Martin Hetschel, Guglingen (DE); Erwin Burkle, Benediktbeuern (DE)

Correspondence Address: Henry M. Feiereisen;Henry M. Feiereisen, LLC, Suite 4714, 350 Fifth Avenue, New York, NY, 10118, US

(73) Assignee: Krauss-Maffei Kunststofftechnik GmbH, Munchen (DE)

(21) Appl. No.: 11/355,496

(22) Filed: Feb. 16, 2006

Related U.S. Application Data
(63) Continuation of application No. PCT/EP04/09076, filed on Aug. 13, 2004.

(30) Foreign Application Priority Data
Aug. 16, 2003 (DE) 103 37 685.2

(51) Int. Cl. H05B 3/68

(52) U.S. Cl. 219/461.1

(57) ABSTRACT

A heatable tool for a device processing plastic melt or metal melt includes a tool body having a tool surface intended for contacting a melt, with the tool body including a tool carrier having a receptacle. An electrically conducting ceramic is constructed as insert for placement in the receptacle for heating at least an area of the tool surface and includes cooling channels for passage of a coolant. The electrically conducting ceramic is arranged on at least one electrically conducting surface for feeding electric energy to the electrically conducting ceramic, wherein electric feed lines to the electrically conducting surface and the cooling channels are constructed for detachable connection such that the electrically conducting ceramic is replaceable with another electrically conducting ceramic for providing a cavity of different configuration.

### CROSS-REFERENCES TO RELATED APPLICATIONS

This application is a continuation of prior filed copending PCT International application no. PCT/EP2004/009076, filed Aug. 13, 2004, which designated the United States and on which priority is claimed under 35 U.S.C. §120, and which claims the priority of German Patent Application, Serial No. 103 37 685.2, filed Aug. 16, 2003, pursuant to 35 U.S.C. 119(a)-(d), the contents of which are incorporated herein by reference.

### BACKGROUND OF THE INVENTION

The present invention relates, in general, to a heatable tool.

Nothing in the following discussion of the state of the art is to be construed as an admission of prior art.

To ensure clarity, it is necessary to establish the definition of several important terms and expressions that will be used throughout this disclosure. The term “plastic melt” relates here to a pure plastic melt as well as to a melt with a certain content of filler material, e.g. glass fiber, ceramic powder, metal powder or other fillers. The content of filler may hereby reach a range of 90% or more. The term “tool” is used in the description in a generic sense, and is intended to cover all kinds of molds and dies used for transforming a melt into a finished or semifinished product. The term “tool” should not be limited to a molding tool for injection molding or extrusion but may also involve hot runners or thermally conductive nozzles as well as any apparatus useful for heating and cooling as well as guiding of melt after production or useful for shortening or eliminating cooling channels.

Tools for use in the plastics processing and metal processing industries for shaping or advancing melt are known. Molding tools are used, for example, in extruders, PUR foaming machines, injection molding machines for thermosetting or thermoplastic materials or in pressure casting machine for shaping a product. A molding tool for defining a cavity normally includes two mold halves or shaping parts, which are so configured as to bound a void, when joined together, whereby the void conforms to the finished product and receives, e.g. through injection, the material being processed, e.g. a plastic melt.

A heatable tool may be applicable as a molding tool for an injection molding machine. When melt or production material is processed in a cavity, care should be taken to heat the cavity surfaces to a temperature that is suited to the material. Oftentimes, a production cycle also requires changing the temperature of the cavity surface. For example, it may be necessary to maintain the temperature during injection at fairly high level, while subsequently reducing the temperature quite significantly to ensure rapid solidification of the melt. In general, the temperature in the cavity and of the cavity surface has a great impact on the quality of the product being produced (optical products such as optical data carriers or lenses). In order to ensure quick cycle times under these circumstances and thus to attain a high productivity, a rapid heating of the molding tools is desired.

Other applications of heating tools involve situations in which the melt should be kept at moderate temperature or heated. When cold runners are involved, the state of the melt may adversely affect quality. When the viscosity changes as a result of a cool down, processing of the melt becomes more difficult. Optimal temperatures are also desired and required, when shaping nozzle tools are involved, for example at the outlet of extruders.

Heretofore, tools and molds are heated using resistance heaters, e.g. on the basis of a resistance wire. These types of resistance heaters can be operated by electric energy, and the heat elements can be conformed to the geometries of the cavity and cavity surfaces. Other examples for heating tools include thick-film heat elements, used predominantly in the field of hot runners.

The use of heat cartridges has the drawback that they are difficult to conform to the contour of the area to be heated. Moreover, they experience long reaction times, when changing the temperature level. In addition, such a heat element may not be exposed to mechanical stress so that at least a slight distance to the surface is required so that the heating capacity and efficiency are adversely affected. The heating capacity of thick-layer heaters in relation to an area ranges from about 5.5 W/cm², and for heating cartridges from about 10 W/cm². Another drawback is the limited service life of conventional heat elements.

German Pat. No. DE 37 12 128 describes a mold insert of technical ceramic for casting and injection molding tools, made of electrically conducting ceramic or metal ceramic on nitride and/or carbide basis. Such a mold insert is applicable for making plastic parts with optical surface quality.

German pat. No. DE 199 42 364 describes a tool for hot forming during compression molding involving the attachment of a formed body of electrically conducting and thus directly heatable ceramic directly beneath a shaping tool in heat-conducting contact therewith. The formed body is thermally and electrically insulated against the shaping machine by an insulation plate.

International PCT application WO 00/54949 discloses a heatable tool, using carbon fibers embedded in a ceramic for realizing the heating operation.

It would therefore be desirable and advantageous to provide an improved heatable tool to obviate prior art shortcomings.

### SUMMARY OF THE INVENTION

According to one aspect of the present invention, a heatable tool for a device processing plastic melt or metal melt, includes a tool body having a tool surface intended for contacting a melt, with the tool body including a tool carrier having a receptacle, and an electrically conducting ceramic constructed as insert for placement in the receptacle for heating at least an area of the tool surface and including cooling channels for passage of a coolant, with the electrically conducting ceramic being arranged on at least one electrically conducting surface for feeding electric energy to the electrically conducting ceramic, wherein electric feed lines to the electrically conducting surface and the cooling channels are constructed for detachable connection such that the electrically conducting ceramic is replaceable with another electrically conducting ceramic for providing a cavity of different configuration.

The present invention resolves prior art problems by providing an electrically conducting ceramic which can be fed with low voltage and high current so that desired temperatures can be reached within a shortest time period. No particular safety concerns need to be observed when using low voltage and such an electrically conducting ceramic can be operated by a control power supply.

According to another feature of the present invention, the electrically conducting ceramic may be made from a silicon-nitride composition having a conductivity-producing substance admixed thereto. The substance may be a titanium-nitride composition and may be added at a range of 0 to 50% by volume or weight. Currently preferred is an addition of this substance of 20 to 40% by volume or weight. In exceptional cases, the added fraction may be higher, even up to 100%.

The provision of cooling channels in the electrically conducting ceramic is advantageous because a superior temperature control can be ensured. In other, a rapid heating action as well as a rapid cool-down action can be realized. The cooling channels may be formed through erosion. A flow of coolant, e.g. gas or liquid enables a temperature adjustment in the electrically conducting ceramic and thus in the tool, as required. Thus, heating and cooling options are established equally.

According to another feature of the present invention, the electrically conducting ceramic may be provided, at least partially, with an electric insulation for electrically insulating the electrically conducting ceramic against other components of the tool and/or the melt. Currently preferred is the application of the insulation on the electrically conducting ceramic by oxidation, with the oxide layer providing the insulation.

According to another feature of the present invention, the electrically conducting ceramic may be constructed with a nanostructure. This is especially suitable, when the electrically conducting ceramic comes into direct contact with the melt. The nanostructure is formed during product manufacture on the surface of the product. Such a process may be applied for example for formation of information such as optical data carriers (CD, DVD, etc.) or to provide the product with a particular, e.g. physical, effect, such as anti-reflection of a lens or change of light transmission in an optical product. Of course, all types of surface structure may be formed on the surface of the electrically conducting ceramic. The nanostructure may, e.g., be provided through material depositing of layers.

According to another feature of the present invention, the electrically conducting ceramic may be embedded in the tool body in the form of a sandwich construction. In other words, the electrically conducting ceramic may be disposed between two components of the tool. Suitably, the electrically conducting ceramic may be disposed in proximity or closely underneath the cavity surface.

As the electrically conducting ceramic may be made of a material having good mechanical properties, e.g. high pressure resistance, it is possible to arrange the electrically conducting ceramic not only directly underneath a surface that comes into contact with the melt (e.g. cavity surface or melt channel) but the electrically conducting ceramic may itself be designed with such a surface. Suitably, the electrically conducting ceramic is then made of wear-resistant material/

According to another feature of the present invention, the electrically conducting ceramic may be cross-linked to the tool or another component of the tool. Suitably, the cross-linked connection may be realized by a diffusion welding process. In this case, the electrically conducting ceramic is not only integrated in the tool but also configured as a part thereof.

According to another feature of the present invention, the electrically conducting ceramic may be part of a tool kit having plural electrically conducting ceramics which can be placed in the receptacle of the tool carrier. This allows easy exchangeability or replacement so as to allow formation of different cavities, so long as the tool carrier has standard dimensions. By configuring the feed lines for the electrically conducting ceramic for detachable connection, the electrically conducting ceramic can simply be removed and exchanged with another electrically conducting ceramic, when the clamping unit is open. Of course, the cavity dimension should not exceed the dimension of the electrically conducting ceramic insert. Such a ceramic insert is useful for example during production of optical data carriers, such as CDs or DVDs, because information can be applied onto the cavity surface of the electrically conducting ceramic instead of using conventional stampers.

According to another feature of the present invention, the tool carrier may be made of tool steel.

According to another feature of the present invention, the electrically conducting ceramic may have a shape and/or surface conforming to a geometry of the surface, e.g. cavity surface or hot runners. The electrically conducting ceramic enables even distribution of the temperature across the surface to be heated. This is required for example for the cavity surface because the temperature of the cavity surface has an impact on the quality of the product being made.

Electric supply to the electrically conducting ceramic may be realized either by normal contacting or through connection of the electrically conducting ceramic onto one or more electrically conducting surfaces. In the latter case, no separate electric feed and drain lines are required. The need for an insulation of the electrically conducting ceramic may hereby be omitted in the area of the contacts.

According to another feature of the present invention, the electrically conducting ceramic may be a component of a ceramic composite having another component in the form of an electrically non-conducting ceramic, with the ceramic composite having heating and cooling zones. The ceramic composite may be made of inexpensive ceramic material, such as for example a silicon-nitride composition, and a more expensive electrically conducting ceramic material, such as for example a silicon—nitride composition admixed with titanium-nitride.

According to another feature of the present invention, the electrically conducting ceramic may have a thickness of 0.5 mm to 4 mm, preferably 1 mm to 3 mm. The thickness may depend on the demanded electric resistance. At such a thickness, the electrically conducting ceramic may not have a desired stability to serve as mold surface for a tool. The use of a composite ceramic addresses this problem as the electrically non-conducting ceramic component may provide the desired stability and in addition may assume the insulation task, with the electrically conducting ceramic being received in the electrically non-conducting ceramic component. The use of a composite ceramic is advantageous as far as physical variables such as heat expansion, pressure resistance etc., is concerned. The electrically non-conducting ceramic component may also be used for formation of a cooling layer with cooling channels. In such a composite ceramic, it is advantageous to crosslink the ceramic components.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a fragmentary sectional view of a first embodiment of a heatable tool according to the present invention;

FIG. 2 is a fragmentary sectional view of a second embodiment of a heatable tool according to the present invention;

FIG. 3 is a fragmentary sectional view of a third embodiment of a heatable tool according to the present invention;

FIG. 4 is a fragmentary sectional view of a tool according to the present invention constructed to form a thermally conductive nozzle;

FIG. 5 is a fragmentary sectional view of a tool according to the present invention constructed to form a further variation of a thermally conductive nozzle; and

FIG. 6 is a fragmentary sectional view of another variation of a tool according to the present invention constructed to form a still further variation of a thermally conductive nozzle.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

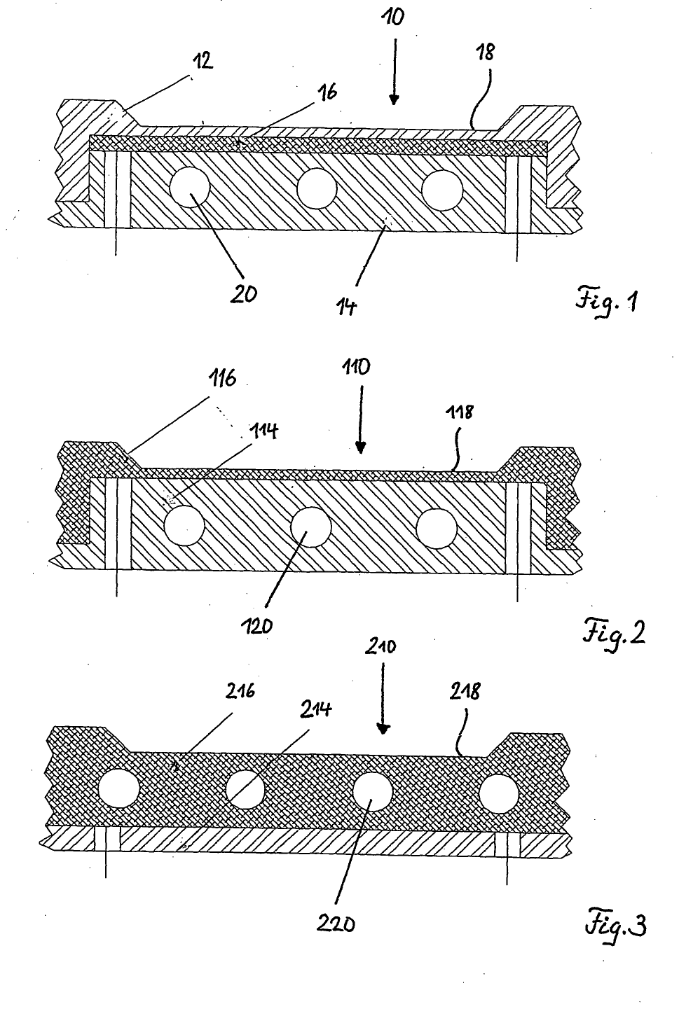

Turning now to the drawing, and in particular to FIG. 1, there is shown a fragmentary sectional view of a first embodiment of a heatable tool according to the present invention, generally designated by reference numeral 10. For ease of understanding, the heatable tool is shown here, by way of example, as a molding tool for use with an injection molding machine and intended for attachment onto an unillustrated platen of a clamping unit of the injection molding machine. Of course, an operative molding tool includes two of such tool portions in order to define a cavity, when joined together, for receiving a plastic melt.

The molding tool, hereinafter called “tool”, includes a base or carrier element 14 which is made of normal tool steel and is formed with coolant channels 20 for optional passage of a coolant, and a tool element 12 which defines a cavity surface 18. Disposed in sandwich construction between the tool element 12 and the carrier element 14 is an electrically conducting ceramic 16 which is made of pressure-resistant material. When applying low voltage, high current flows through the electrically conducting ceramic 16 so as to raise the temperature of the electrically conducting ceramic 16 quickly to an elevated level. As a result of the mechanical pressure-resistance, the electrically conducting ceramic 16 can be positioned in immediate proximity of the cavity surface 18. This ensures that the temperature generated by the electrically conducting ceramic 16 quickly reaches the cavity surface 18. As shown in FIG. 1, the cavity surface 18 extends parallel to the electrically conducting ceramic 16. In the event, the cavity surface 18 has a different configuration, the electrically conducting ceramic 16 can be shaped to complement the respective geometry of the cavity surface.

The electrically conducting ceramic 16 is provided with electric contacts, indicated by continuous lines representing feed lines, to generate the current flow through the electrically conducting ceramic 16. Although not shown in detail, the electrically conducting ceramic 16 is connected to a control power supply which may be constructed of simple design and may constitute a separate element or integrated in the controller of the electric injection molding machine.

FIG. 2 shows a fragmentary sectional view of a second embodiment of a heatable tool according to the present invention, generally designated by reference numeral 110. Parts corresponding with those in FIG. 1 are denoted by corresponding reference numerals each increased by “100”. The description below will center on the differences between the embodiments. In this embodiment, the tool element 12 is omitted and the electrically conducting ceramic 116 forms the cavity surface 118 and is disposed on a base or carrier element 114 having cooling channels 120. The direct configuration of the cavity surface 118 upon the electrically conducting ceramic 116 enables generation of heat precisely at the location where it is required. As a result, the cavity surface 118 can be rapidly heated up. In combination with a passage of coolant through the cooling channels 120, cool down may also be executed quickly so that the temperature can be controlled in a desired manner. The electrically conducting ceramic 116 ensures hereby a high heating capacity in relation to the area being heated.

Although not shown in detail, the cavity surface 118 of the electrically conducting ceramic 116 may be formed with a structure or texture, e.g. a nanostructure which can be applied through depositing material layers.

The electrically conducting ceramic 116 is suitably made of highly wear-resistant ceramic material and is electrically insulated by applying an oxide layer on the surface of the electrically conducting ceramic 116. As the electrically conducting ceramic 116 is fed with low voltage, the operation of the electrically conducting ceramic 116 can easily be executed in the absence of stringent demands as far as operating safety is concerned.

FIG. 3 shows a fragmentary sectional view of a third embodiment of a heatable tool according to the present invention, generally designated by reference numeral 210. Parts corresponding with those in FIG. 1 are denoted by corresponding reference numerals each increased by “200”. The heatable tool 210 is a variation of the heatable tool 110, with the difference residing in a thicker or wider configuration of the electrically conducting ceramic 216 and an integration of the cooling channels 220 in the electrically conducting ceramic 216. Suitably, the cooling channels 220 are formed through an erosion process. The tool 210 can thus basically be established through respective construction of the electrically conducting ceramic 216 with the cavity surface 218 and the cooling channels 220. It is only necessary to connect the electrically conducting ceramic 216 onto the respective base or carrier element 214 which may be provided with feed and drain lines for the electric supply of the electrically conducting ceramic 216. The construction of the tool 210 thus enables heating and cooling actions in close proximity to the surfaces, so that very short reaction times and superior efficiency as far as heating and cooling are concerned can be accomplished.

The electrically conducting ceramic 216 may be constructed as exchangeable insert which can be placed upon the carrier element 214. The electric insulation at the contacts may be omitted so that a direct electrical contact with the feed can be established when the electrically conducting ceramic 216 is attached to the carrier element 214. The connection of the cooling channels 220 to the overall cooling system is detachably constructed so that the electrically conducting ceramic 216 as insert can be easily and rapidly exchanged. The heating and cooling capacity of the electrically conducting ceramic 216 can thus be suited to the need at hand through appropriate selection of electrically conducting ceramics 216.

Referring now to FIG. 4, there is shown a fragmentary sectional view of a tool for use as a thermally conductive nozzle, generally designated by reference numeral 50 and including a heat-conducting channel 52 for conduction of melt flowing from the right-hand side and exiting the nozzle 50 on the left-hand side. To maintain the heat-conducting channel 52 at an appropriate temperature, an electrically conducting ceramic 54 is incorporated, as will be described hereinafter. The thermally conductive nozzle 50 includes a housing 56 in which the electrically conducting ceramic 54 is embedded. The electrically conducting ceramic 54 may have a tubular configuration in coaxial relationship to the heat-conducting channel 52 and extends substantially along the entire length of the housing 56 of the thermally conductive nozzle 50, with a narrow housing portion 53 separating the electrically conducting ceramic 54 from the heat-conducting channel 52. Of course, heat can be generated at the desired location more rapidly with decreasing width of the housing portion 53 and thus decreasing distancing between the electrically conducting ceramic 54 and the heat-conducting channel 52.

Optionally, the electrically conducting ceramic 54 may be cross-linked to the housing 56, e.g. through a diffusion welding process.

FIG. 5 shows a variation of a thermally conductive nozzle, generally designated by reference numeral 154. Parts corresponding with those in FIG. 4 are denoted by corresponding reference numerals each increased by “100”. The description below will center on the differences between the embodiments. In this embodiment, a portion of the heat-conducting channel 152 is defined by the electrically conducting ceramic 154 so that the provision of a thin housing portion is omitted. As a result, heat is generated exactly at the location where it is needed. In addition, the housing 156 may be used as mounting for the electrically conducting ceramic 154.

Optionally, the electrically conducting ceramic 154 may be cross-linked to the housing 156, e.g. through a diffusion welding process.

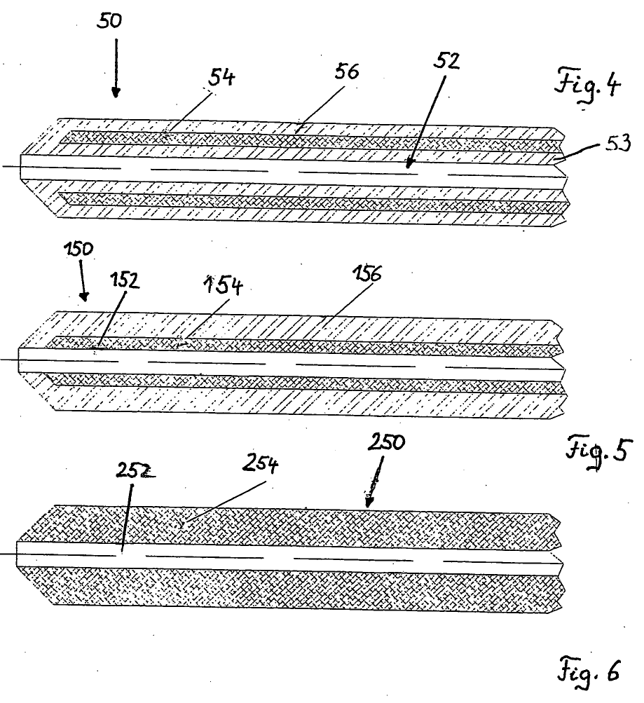

FIG. 6 shows yet another variation of a thermally conductive nozzle, generally designated by reference numeral 254. Parts corresponding with those in FIG. 4 are denoted by corresponding reference numerals each increased by “200”. This embodiment differs from the preceding embodiments by the absence of a separate housing. The thermally conductive nozzle 250 is made entirely of the electrically conducting ceramic 254 which is formed with the heat-conducting channel 252. This embodiment requires separate attachment of contacts and the ceramic material used should have sufficient stability and wear-resistance. In addition, the electrically conducting ceramic 254 should be electrically insulated, at least to the outside.

A tool according to the present invention may also be applicable for use as an extrusion die (e.g. pipe die head) at the exit end of an extruder.

The provision of an electrically conducting ceramic, as described above, results in a rapid heating of a tool surface that comes into contact with a melt. The tool has a long service life and is reliable in operation. This is also realized by the high heating capacity in relation to the area being heated as well as the high pressure resistance so that the electrically conducting ceramic may be arranged directly beneath the surface or itself form part of the surface. Many advantages can be attained through suitable combination of any of the other features such as provision of an integrated cooling, application of a structure directly on the surface of the electrically conducting ceramic in contact with the melt, provision of a ceramic composite comprised of the electrically conducting ceramic and an electrically non-conducting ceramic, or construction of the electrically conducting ceramic as exchangeable insert.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A heatable tool for a device processing plastic melt or metal melt, comprising:
a tool body having a tool surface intended for contacting a melt, said tool body including a tool carrier having a receptacle; and
an electrically conducting ceramic constructed as insert for placement in the receptacle for heating at least an area of the tool surface and including cooling channels for passage of a coolant, said electrically conducting ceramic being arranged on at least one electrically conducting surface for feeding electric energy to the electrically conducting ceramic,
wherein electric feed lines to the electrically conducting surface and the cooling channels are constructed for detachable connection such that the electrically conducting ceramic is replaceable with another electrically conducting ceramic for providing a cavity of different configuration.

2. The tool of claim 1, wherein the electrically conducting ceramic forms part of the tool surface.

3. The tool of claim 1, wherein the electrically conducting ceramic is disposed in close proximity to the tool surface.

4. The tool of claim 1, wherein the electrically conducting ceramic is provided, at least partially, with an electric insulation for electrically insulating the electrically conducting ceramic against other components of the tool and/or the melt.

5. The tool of claim 4, wherein the insulation is applied on the electrically conducting ceramic by oxidation.

6. The tool of claim 1, wherein the electrically conducting ceramic is constructed with a nanostructure.

7. The tool of claim 6, wherein the nanostructure is provided through material depositing of layers.

8. The tool of claim 1, wherein the electrically conducting ceramic is a component of a ceramic composite having an other component in the form of an electrically non-conducting ceramic, said ceramic composite having heating and cooling zones.

9. The tool of claim 1, wherein the electrically conducting ceramic is made of a silicon-nitride composition having a conductivity-producing substance admixed thereto.

10. The tool of claim 9, wherein the substance is a titanium-nitride composition.

11. The tool of claim 9, wherein the substance is added at a range of 0 to 50% by volume or weight.

12. The tool of claim 9, wherein the substance is added at a range of 10 to 40% by volume or weight.

13. The tool of claim 1, wherein the electrically conducting ceramic has a thickness of 0.5 mm to 4 mm.

14. The tool of claim 1, wherein the electrically conducting ceramic has a thickness of 1 mm to 3 mm.

15. The tool of claim 8, wherein the ceramic composite has a common base composition for the electrically conducting ceramic and the electrically non-conducting ceramic.

16. The tool of claim 15, wherein the electrically conducting ceramic and the electrically non-conducting ceramic are cross-linked to one another.

17. The tool of claim 8, wherein the ceramic composite is constructed as an exchangeable tool insert.

18. The tool of claim 1, wherein the electrically conducting ceramic is operated by low voltage and high current for realizing a sufficient heating capacity.

19. The tool of claim 1, further comprising a control power supply for operating the electrically conducting ceramic.

20. The tool of claim 1, wherein the electrically conducting ceramic is embedded in the tool body in the form of a sandwich construction.

21. The tool of claim 20, wherein the electrically conducting ceramic is disposed in proximity or closely underneath the tool surface.

22. The tool of claim 1, wherein the electrically conducting ceramic is connected to a further component of the tool by cross-linking.

23. The tool of claim 22, wherein the further component is a housing part or a carrier part.

24. The tool of claim 22, wherein the cross-linked connection is realized by a diffusion welding process.

25. The tool of claim 1, wherein the electrically conducting ceramic has a surface which is intended for contacting the melt during operation.

26. The tool of claim 25, wherein the electrically conducting ceramic is constructed to form a cavity surface or a hot runner portion.

27. The tool of claim 1, wherein the electrically conducting ceramic is made of a wear-resistant ceramic material.

28. The tool of claim 1, wherein the cooling channels in the electrically conducting ceramic are provided through erosion.

29. The tool of claim 1, wherein the tool carrier is made of tool steel.

30. The tool of claim 1, wherein the electrically conducting ceramic has a shape and/or surface conforming to a geometry of the cavity surface.

31. The tool of claim 1, wherein the tool surface bounds at least part of the cavity.

32. The tool of claim 1, wherein the tool body is a thermally conductive nozzle.

33. The tool of claim 1, wherein the tool body is a hot runner.

34. The tool of claim 1, wherein the tool body is constructed as a die for an extruder.
